(19) United States
(12) Patent Application Publication
(10) Pub. No.: US 2026/0226836 A1
(43) Pub. Date: Aug. 6, 2026

(54) GAS TURBINE ENGINES, TURBINE COMPONENTS HAVING AIRFOIL COOLING SLOTS, AND METHODS FOR PRODUCING THE SAME

(71) Applicant: HONEYWELL INTERNATIONAL INC., Charlotte, NC (US)

(72) Inventors: Benjamin Kamrath, Mesa, AZ (US); Daniel Crites, Phoenix, AZ (US); Ardeshir Riahi, Phoenix, AZ (US); Mark Morris, Phoenix, AZ (US); Paul Kurlak, Phoenix, AZ (US)

(73) Assignee: HONEYWELL INTERNATIONAL INC., Charlotte, NC (US)

(21) Appl. No.: 19/043,671

(22) Filed: Feb. 3, 2025

(51) Int. Cl. F01D 5/18

(52) U.S. Cl. CPC F01D 5/186; F01D 5/187; F05D 2260/202

(57) ABSTRACT

Turbine components having cooling slots and methods of producing the same are provided. The turbine components include an airfoil having a pressure side and a suction side, passages within the airfoil, and slots open to the pressure side adjacent the trailing edge. The slots are in fluidic communication with the passages and configured to discharge a cooling fluid therefrom. The slots are defined by a slot upper side wall, a slot lower side wall, a pressure side surface, and a slot bottom. The pressure side surface includes a pressure side upper wall fillet coupled to the slot upper side wall and a pressure side lower wall fillet coupled to the slot lower side wall. Edges of the pressure side upper and lower wall fillets have a combined dimension equal to or greater than 30 percent of a total dimension of the pressure side surface.

### TECHNICAL FIELD

The present invention generally relates to gas turbine engines, and more particularly relates to turbine components with airfoil trailing edge cooling slots.

### BACKGROUND

Gas turbine engine airfoils may incorporate internal cooling circuits to improve heat transfer and enhance cooling within the airfoil. Each airfoil typically features a concave pressure side surface and a convex suction side surface, both extending longitudinally or radially outward from the airfoil base to the tip, and axially between the leading and trailing edges. For a turbine blade, the airfoil's span extends from the root at the radially inner platform to the outer tip, which is spaced from the surrounding turbine shroud. In the case of a turbine vane, the airfoil spans from the root, which is integrated with the radially inner band, to the outer tip, which is integrated with the outer band. The thin trailing edge of each airfoil is generally protected by a row of trailing-edge cooling slots that breach the pressure side surface just upstream of the trailing edge. These slots discharge film cooling air from the internal cooling circuits to protect the trailing edge from excessive heat and to expel spent cooling air from the internal cooling circuits.

Cooled airfoils can be a significant durability cost for current gas turbine engines, and adequate cooling can significantly improve the usable lifespan of a turbine component. However, next generation gas turbine engines are expected to have increased operating temperatures. Hence, there is an ongoing desire for systems and methods capable of promoting airfoil cooling for gas turbine components. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various examples, a turbine component is provided that includes an airfoil having an upper end, a lower end, a leading edge, a trailing edge, a pressure side surface, and a suction side surface, a cooling system that includes a plurality of passages within the airfoil that are configured to flow a cooling fluid therethrough, and slots open to the pressure side surface of the airfoil adjacent the trailing edge thereof. The slots are in fluidic communication with the plurality of passages and configured to discharge the cooling fluid therefrom. The slots are each defined by a slot upper side wall and an oppositely disposed slot lower side wall, the pressure side surface, and a slot bottom defined by the suction side surface. The pressure side surface includes a pressure side upper wall fillet coupled to the slot upper side wall and a pressure side lower wall fillet coupled to the slot lower side wall. Edges of the pressure side upper wall fillet and the pressure side lower wall fillet have a combined dimension equal to or greater than 30 percent of a total dimension of an edge of the pressure side surface at an exit of the plurality of passages.

In various examples, a method is provided that includes forming a turbine component that includes an airfoil having an upper end, a lower end, a leading edge, a trailing edge, a pressure side surface, and a suction side surface, forming a cooling system that includes a plurality of passages within the airfoil that are configured to flow a cooling fluid therethrough, and forming slots in the airfoil open to the pressure side surface of the airfoil adjacent the trailing edge thereof, the slots in fluidic communication with the plurality of passages and configured to discharge the cooling fluid therefrom. The slots are each defined by a slot upper side wall and an oppositely disposed slot lower side wall, the pressure side surface, and a slot bottom defined by the suction side surface. The pressure side surface includes a pressure side upper wall fillet coupled to the slot upper side wall and a pressure side lower wall fillet coupled to the slot lower side wall. Edges of the pressure side upper wall fillet and the pressure side lower wall fillet have a combined dimension equal to or greater than 30 percent of a total dimension of an edge of the pressure side surface at an exit of the plurality of passages.

In various examples, a gas turbine engine is provided that includes a compressor section, a combustor section, and a turbine section having a turbine component that includes an airfoil having an upper end, a lower end, a leading edge, a trailing edge, a pressure side surface, and a suction side surface, a cooling system that includes a plurality of passages within the airfoil that are configured to flow a cooling fluid therethrough, and slots open to the pressure side surface of the airfoil adjacent the trailing edge thereof, the slots in fluidic communication with the plurality of passages and configured to discharge the cooling fluid therefrom. The slots are each defined by a slot upper side wall and an oppositely disposed slot lower side wall, the pressure side surface, and a slot bottom defined by the suction side surface. The pressure side surface includes a pressure side upper wall fillet coupled to the slot upper side wall and a pressure side lower wall fillet coupled to the slot lower side wall. Edges of the pressure side upper wall fillet and the pressure side lower wall fillet have a combined dimension equal to or greater than 30 percent of a total dimension of an edge of the pressure side surface at an exit of the plurality of passages. The slots are coupled to the plurality of passages by metering sections, and the pressure side upper wall fillet and the pressure side lower wall fillet, in combination, extend the metering sections aft toward the trailing edge of the airfoil to an extent sufficient to provide attenuation of stress concentrations, inhibit flow path hot gas ingestion into the slot, and enhance lateral diffusion of the flow of the cooling fluid from the slot. The slot upper side wall and the slot bottom are coupled with an upper slot side wall fillet and the slot lower side wall and the slot bottom are coupled with a lower slot side wall fillet, and both the upper slot side wall fillet and the lower slot side wall fillet have monotonically increasing radii of curvature from the exit of the plurality of passages to a trailing edge of the slot. Each of the slots have a central axis extending from the exit of the plurality of passages to a trailing edge of the slot, wherein edges of the slot upper side wall and the slot lower side wall flare outward from the central axis, and the slots are separated by tapering teardrop-shaped lands.

Furthermore, other desirable features and characteristics of the turbine component, method, and gas turbine engine will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a schematic cross-sectional illustration of a gas turbine engine, which includes an exemplary turbine component in accordance with aspects of an embodiment;

FIG. 2 is a detail cross-sectional view of the gas turbine engine of FIG. 1, taken at box 2 of FIG. 1, which illustrates an airfoil of the turbine component in accordance with aspects of an embodiment;

FIG. 3 is a planar view of the turbine component of FIGS. 1-2, taken at box 3 of FIG. 2, which illustrates trailing edge cooling slots of the turbine component in accordance with aspects of an embodiment;

FIG. 4 is a cross-sectional view of one of the trailing edge cooling slots of FIG. 3 along a geometric plane perpendicular to the view of FIG. 3 in accordance with aspects of an embodiment;

FIG. 5 is a perspective view of the trailing edge cooling slots of FIG. 3 in accordance with aspects of an embodiment; and

FIG. 6 is a flowchart illustrating an exemplary method for forming a turbine component in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Systems and methods disclosed herein provide for gas turbine engine components that include airfoils having trailing edge cooling slots that promote improved thermal operating conditions for the airfoils. In some examples, the cooling slots further promote improved aerodynamic operating conditions and/or improved structural properties.

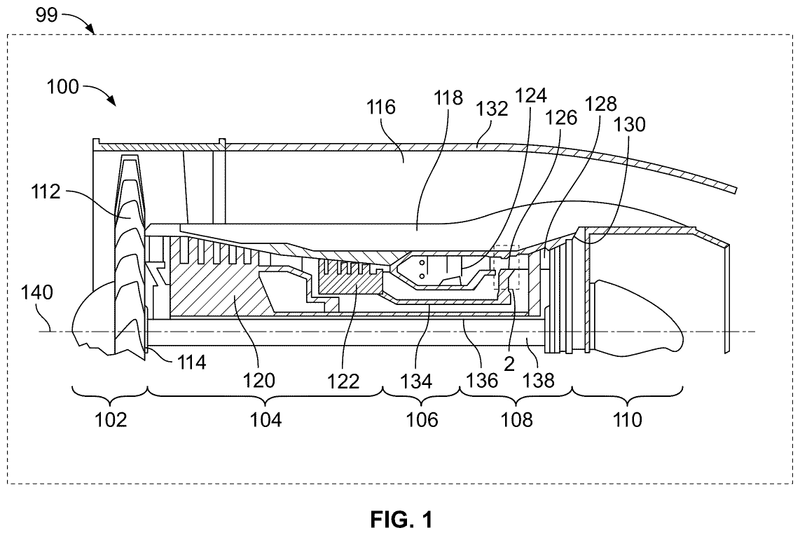

With reference to FIG. 1, a partial, cross-sectional view of an exemplary gas turbine engine 100 is shown with the remaining portion of the gas turbine engine 100 being axisymmetric about a longitudinal axis 140, which also comprises an axis of rotation for the gas turbine engine 100. In the depicted embodiment, the gas turbine engine 100 is an annular multi-spool turbofan gas turbine jet engine within an aircraft 99, although other arrangements and uses may be provided.

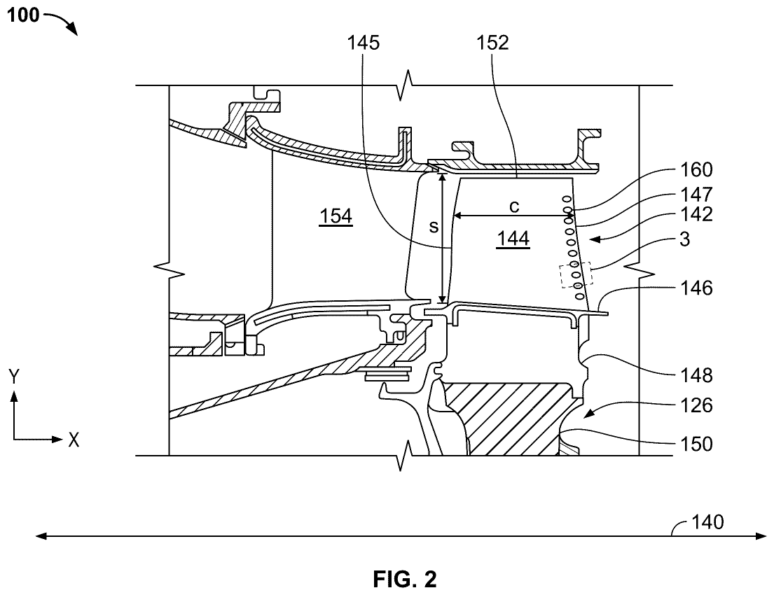

In this example, the gas turbine engine 100 includes fan section 102, a compressor section 104, a combustor section 106, a turbine section 108, and an exhaust section 110. The fan section 102 includes a fan 112 mounted on a rotor 114 that draws air into the gas turbine engine 100 and accelerates it. A fraction of the accelerated air exhausted from the fan 112 is directed through an outer (or first) bypass duct 116 and the remaining fraction of air exhausted from the fan 112 is directed into the compressor section 104. The outer bypass duct 116 is generally defined by an inner casing 118 and an outer casing 132. In the embodiment of FIG. 1, the compressor section 104 includes an intermediate pressure compressor 120 and a high-pressure compressor 122. However, in other embodiments, the number of compressors in the compressor section 104 may vary. In the depicted embodiment, the intermediate pressure compressor 120 and the high-pressure compressor 122 sequentially raise the pressure of the air and direct a majority of the high-pressure air into the combustor section 106. A fraction of the compressed air bypasses the combustor section 106 and is used to cool, among other components, turbine blades 142 (FIG. 2) in the turbine section 108 via an inner bypass duct.

In the embodiment of FIG. 1, in the combustor section 106, which includes a combustion chamber 124, the high-pressure air is mixed with fuel and combusted. The high temperature combusted air is directed into the turbine section 108. In this example, the turbine section 108 includes three turbines disposed in axial flow series, namely, a high-pressure turbine 126, an intermediate pressure turbine 128, and a low-pressure turbine 130. However, it will be appreciated that the number of turbines, and/or the configurations thereof, may vary. In this embodiment, the high-temperature combusted air from the combustor section 106 expands through and rotates each turbine 126, 128, and 130. As the turbines 126, 128, and 130 rotate, each drives equipment in the gas turbine engine 100 via concentrically disposed shafts or spools. In one example, the high-pressure turbine 126 drives the high-pressure compressor 122 via a high-pressure shaft 134, the intermediate pressure turbine 128 drives the intermediate pressure compressor 120 via an intermediate pressure shaft 136, and the low-pressure turbine 130 drives the fan 112 via a low-pressure shaft 138.

With reference to FIG. 2, a portion of the high-pressure turbine 126 of the gas turbine engine 100 of FIG. 1 (designated by box 2 in FIG. 1) is shown in greater detail. In this example, the high-pressure turbine 126 includes a high-pressure turbine blade 142 having a turbine airfoil 144 with trailing edge cooling slots 160. However, it should be noted that the trailing edge cooling slots 160 may be used on other airfoils within the gas turbine engine 100 such as, but not limited to, high-pressure turbine vanes 154. Further, it should be noted that the trailing edge cooling slots 160 are not limited to any particular application. In some examples, the gas turbine engine 100 may be included with an auxiliary power unit and/or various types of engines, including, but not limited to, turbofan, turboprop, turboshaft, and turbojet engines, whether deployed onboard an aircraft, watercraft, or ground vehicle (e.g., a tank), included within industrial power generators, or utilized within another platform or application.

The exemplary embodiment of the high-pressure turbine 126 includes at least one row of the circumferentially spaced apart turbine blades 142. Each of the turbine blades 142 includes one of the turbine airfoils 144 integrally formed with a platform 146 and an axial entry dovetail 148 used to mount the turbine blade 142 on a perimeter of a supporting rotor disk 150.

Referring to FIGS. 2-5, the turbine airfoil 144 extends radially outwardly along a span S from an airfoil base (i.e., connection between the turbine airfoil 144 and the platform 146; not shown) on the platform 146 to an airfoil tip 152. During operation, the hot combustion gases are generated in the engine 100 and flow downstream past the high-pressure turbine vane 154 and over the turbine airfoil 144 which extracts energy therefrom for rotating the rotor disk 150 supporting the turbine blade 142 for powering the high-pressure compressor 122. A portion of pressurized air is suitably cooled and directed to the turbine blade 142 bypassing the combustor, for cooling thereof during operation.

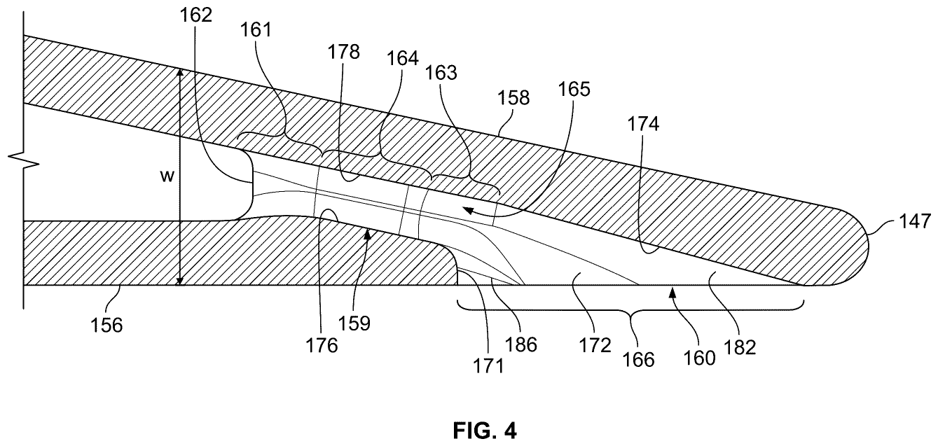

The turbine airfoil 144 includes widthwise spaced apart generally concave pressure and convex suction side surfaces 156, 158 (FIG. 4). The pressure and suction side surfaces 156, 158 extend longitudinally or radially outwardly along the span S from the airfoil base to the airfoil tip 152. The pressure and suction side surfaces 156, 158 also extend axially in a chordwise direction C between opposite leading and trailing edges 145, 147. The turbine airfoil 144 is hollow with the pressure and suction side surfaces 156, 158 being spaced widthwise or laterally apart between the leading and trailing edges 145, 147 to define an internal cooling cavity or circuit therein having a plurality of passages for circulating pressurized cooling air or coolant flow during operation. The pressurized cooling air or coolant flow is from the portion of pressurized air diverted from the high-pressure compressor 122. The turbine airfoil 144 increases in width W (FIG. 4) or widthwise from the leading edge 145 to a maximum width aft therefrom and then converges to a relatively thin or sharp trailing edge 147. The size of the internal cooling circuit therefore varies with the width of the turbine airfoil 144, and is relatively thin immediately forward of the trailing edge 147 where the pressure and suction side surfaces 156, 158 integrally join together and form a thin trailing edge portion of the turbine airfoil 144. Spanwise spaced apart trailing edge cooling slots 160 are provided at or near this thin trailing edge portion of the turbine airfoil 144 to cool it.

A row of the spanwise spaced apart trailing edge cooling holes 159 encased or buried and formed in the turbine airfoil 144 between the pressure and suction side surfaces 156, 158 end at corresponding ones of the spanwise spaced apart trailing edge cooling slots 160. The trailing edge cooling slots 160 extend chordally substantially to the trailing edge 147. The trailing edge cooling holes 159 are disposed along the span S of the trailing edge 147 in flow communication with the internal cooling circuit for metering and discharging the coolant flow therefrom during operation.

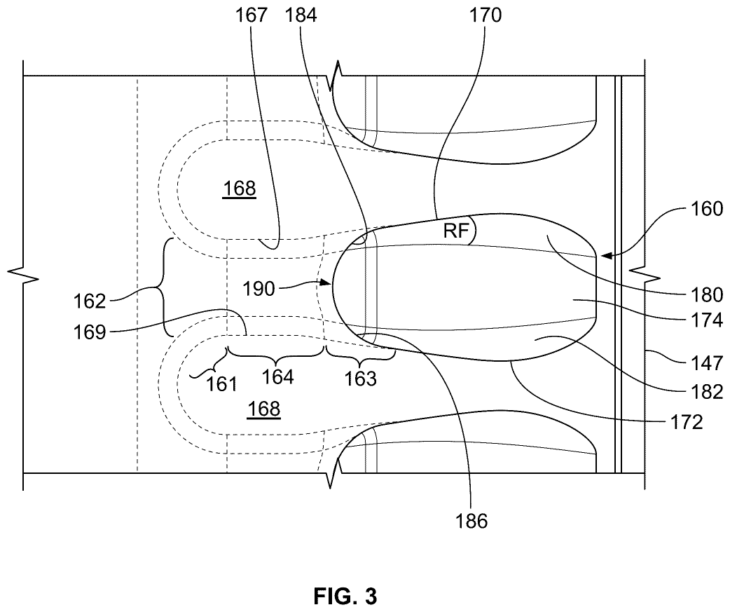

The trailing edge cooling holes 159 are illustrated in more particularity in FIG. 4. Each cooling hole 159 includes in downstream serial cooling flow relationship, a downstream converging or curved inlet 162, a converging section 161, a slot flow metering section 164, and a diverging section 163 which leads into the trailing edge cooling slot 160 and supplies the cooling slot 160 with cooling air or coolant flow. The trailing edge cooling slot 160 begins at a cooling hole exit 165 at a downstream end of the slot flow metering section 164. Pairs of the cooling holes 159 and cooling slots 160 are separated radially along the span S from each other by corresponding lands 168 (FIG. 3) which extend downstream toward the trailing edge 147.

The curved inlet 162 is defined at and between the lands 168. The lands 168 include semi-circular forward ends having diameters that define the curved inlets 162. Each of the cooling holes 159 includes spanwise spaced apart upper and lower hole surfaces 167, 169 along a corresponding adjacent pairs of the lands 168. The adjacent pair of the lands 168 and the upper and lower hole surfaces 167, 169 spanwise bound the cooling holes 159. Pressure-side and suction-side surfaces 176, 178 of the pressure and suction side surfaces 156, 158, respectively, widthwise bound the cooling holes 159.

The trailing edge cooling slots 160 breach the external surface of the pressure side surface 156 at the slot breakout 166 spaced forward or upstream from the trailing edge 147. Each trailing edge cooling slot 160 is radially or spanwise bounded by the exposed lands 168. One embodiment of the lands 168 are coplanar or flush with the external surface of the pressure side surface 156 around each of the exposed cooling slots 160. This may promote flow continuity of the pressure side surface 156 of the turbine airfoil 144.

The trailing edge cooling slots 160 include a slot floor 174 open and exposed to the hot combustion gases that pass through the high-pressure turbine 126. Slot surfaces extend widthwise between the lands 168 and the slot floors 174. Slot upper and lower side walls 170, 172 are defined by the lands 168. Upper and lower side wall fillets 180, 182 in slot corners between the slot upper and lower side walls 170, 172 and the slot floors 174 have fillet radii RF. In some examples, the fillet radii RF may monotonically increase in radius of curvature from the slot exit toward the trailing end of the cooling slots 160. In conjunction with the tapering teardrop-shaped lands 168, the monotonically increasing radius of curvature of the upper and lower side wall fillets 180, 182 promote efficient diffusion of the slot film cooling in the lateral (radial) direction and provide conduction paths for lateral diffusion of the hot trailing edge metal temperatures between the cooling slots 160. These features may also function to inhibit the hot gas ingestion vortices from rolling off the lands 168 and mixing with the film cooling of the slot floor 174, thus enhancing the cooling of the trailing edge 147. Each of the cooling slots 160 have a central axis extending from the exit of the plurality of passages to a trailing edge of the cooling slot 160. In some examples, edges of the slot upper side wall 170 and the slot lower side wall 172 may flare outward from the central axis spanwise.

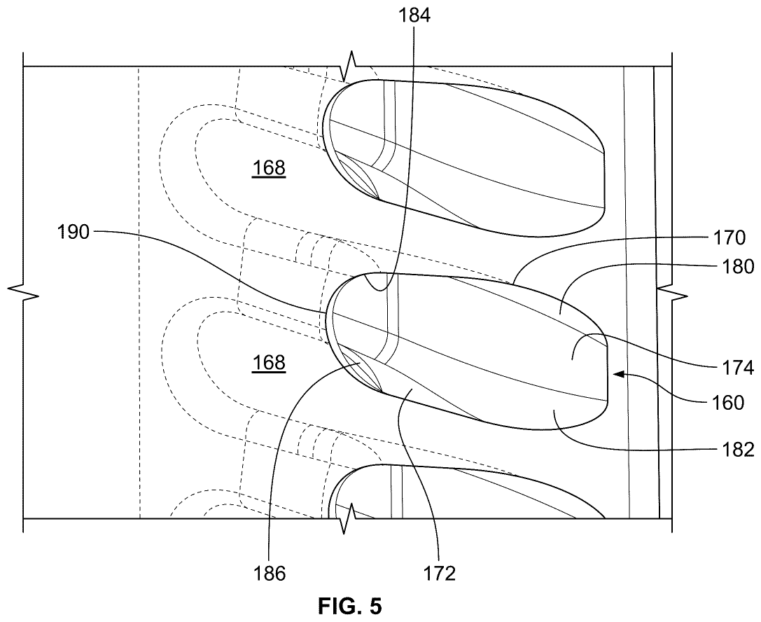

The cooling slots 160 further include a cooling hole breakout lip 171 defined by pressure-side upper and lower wall fillets 184, 186 (FIG. 5). Notably, the pressure-side upper and lower wall fillets 184, 186 may define a significant portion of the breakout lip 171. In some examples, the pressure-side upper and lower wall fillets 184, 186 may have a combined dimension equal to or greater than 30 percent of a total dimension of the breakout lip 171 of the pressure side surface 156 (i.e., the leading edge of the cooling slot 160 defined by the pressure side surface at the exit of the cooling hole 159), such as equal to or greater than 40 percent, such as equal to or greater than 50 percent, such as equal to or greater than 60 percent, such as equal to or greater than 70 percent, such as equal to or greater than 80 percent, such as equal to or greater than 90 percent, such as equal to 100 percent (i.e., an entirety of the breakout lip 171). For examples in which the pressure-side upper and lower wall fillets 184, 186 define an entirety of the breakout lip 171, the pressure-side upper and lower wall fillets 184, 186 may be referred to as meeting at a tangent point 190. The radius of curvature of the pressure-side upper and lower wall fillets 184, 186 may be uniform or may vary.

Notably, certain existing cooling slots of airfoils utilize a flat or linear transition between the pressure side upper and lower wall fillets at the cooling hole exit to minimize surface areas of the cooling slot in contact with the hot gases passing thereby during operation. Increasing the combined dimension of the pressure-side upper and lower wall fillets 184, 186 increases the surface area in contact with hot gasses and therefore would be expected to degrade thermal performance of the turbine airfoil 144, especially to combined dimensions of equal to or greater than 30 percent. Counter-intuitively, providing the pressure-side upper and lower wall fillets 184, 186 as described herein with increased combined dimensions was determined to improve the thermal performance of the cooling slots 160 and the turbine airfoil 144 (i.e., reduce peak metal temperatures). In general, it was determined that the thermal performance was improved with increasing combined dimensions of the pressure-side upper and lower wall fillets 184, 186. While not intending to be limited to any particular theory, it is believed that the increase in the size of the pressure-side upper and lower wall fillets 184, 186 provides thermal conduction paths to promote lateral thermal diffusion and promotes contact between the breakout lip 171 and the cooling air exiting the cooling holes 159 which has a net thermal benefit despite increasing the surface area exposed to the hot gases. By reducing peak metal temperatures, oxidation and thermomechanical fatigue distress may be significantly improved relative to existing airfoil cooling slots having a flat or linear transition between the pressure side upper and lower wall fillets. In some examples, the increased size of the pressure-side upper and lower wall fillets 184, 186 may reduce the likelihood of the hot gas mixing into the slot film cooling stream.

In addition to thermal benefits, the increased size of the pressure-side upper and lower wall fillets 184, 186 attenuates stress concentration at the breakout lip 171, thereby promoting durability of the cooling slots 160. For example, stress analyses indicated that the increased size of the pressure-side upper and lower wall fillets 184, 186 may reduce peak stresses in the trailing edge slot region by thirty percent or more along the slot floor 174 and by about 50 percent along the pressure side surface 156.

The increased size of the pressure-side upper and lower wall fillets 184, 186 was determined to improve lateral diffusion of the slot film to an extent sufficient to reduce the trailing edge wake vortices of the turbine airfoil 144. This reduction in the trailing edge wake vortices promotes a reduction in the aerodynamically effective trailing edge thickness, which in turn promotes a reduction in aerodynamic losses in the turbine airfoil 144. It was determined that this effect may be further promoted by providing a monotonically increase in radius of curvature of the fillet radii RF of the upper and lower side wall fillets 180, 182 toward the trailing end of the cooling slots 160 as discussed previously which was determined to promote a reduction in entrainment of vorticities rolling off the corners of the hot lands 168 into the upper and lower side wall fillets 180, 182.

The trailing edge cooling slots 160 and the lands 168 may be cast-in cooling features. Casting these features may promote strength, low manufacturing costs, and durability for the turbine airfoil 144.

Notably, the cooling slots 160 may include various combinations of the features disclosed herein. In some examples, such as those shown and described previously, the cooling slots 160 may include the pressure-side upper and lower wall fillets 184 having a combined dimension of equal to or greater than thirty percent of the total dimension of the breakout lip 171, and include the upper and lower side wall fillets 180, 182 having the monotonically increasing radius of curvature. In other examples, the cooling slots 160 may include the pressure-side upper and lower wall fillets 184 having a combined dimension of equal to or greater than thirty percent of the total dimension of the breakout lip 171, but include the upper and lower side wall fillets 180, 182 that do not have the monotonically increasing radius of curvature. In yet other examples, the cooling slots 160 may include the upper and lower side wall fillets 180, 182 having the monotonically increasing radius of curvature, but include the pressure-side upper and lower wall fillets 184 having a combined dimension of less than thirty percent of the total dimension of the breakout lip 171.

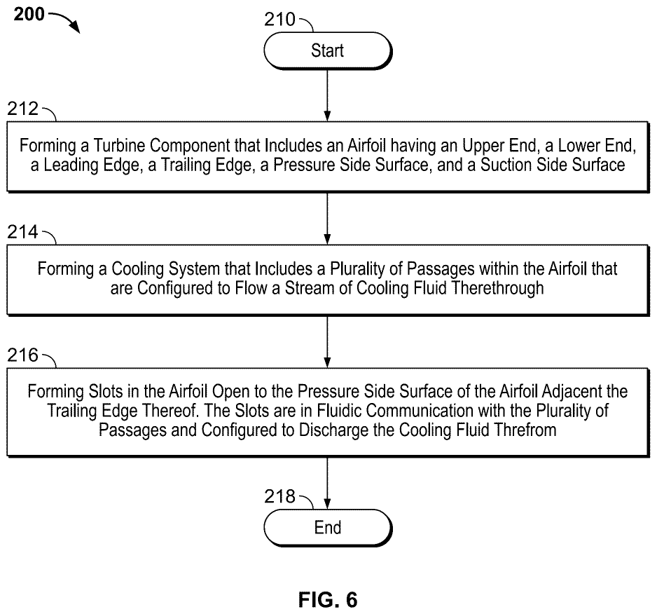

The systems disclosed herein, including the gas turbine engine 100, provide for methods of producing turbine components and/or operating engines. For example, FIG. 6 is a flowchart illustrating an exemplary method 200 for producing a turbine component, such as the turbine blade 142. The method 200 may start at 210. At 212, the method 200 may include forming a turbine component that includes an airfoil having an upper end, a lower end, a leading edge, a trailing edge, a pressure side surface, and a suction side surface. At 214, the method 200 may include forming a cooling system that includes a plurality of passages within the airfoil that are configured to flow a stream of cooling fluid therethrough. At 216, the method 200 may include forming slots in the airfoil open to the pressure side surface of the airfoil adjacent the trailing edge thereof. The slots are in fluidic communication with the plurality of passages and configured to discharge the cooling fluid therefrom. The slots are each defined by edges of a slot upper side wall and an oppositely disposed slot lower side wall, the pressure side surface, and a slot bottom defined by the suction side surface. The pressure side surface includes a pressure side upper wall fillet coupled to the slot upper side wall and a pressure side lower wall fillet coupled to the slot lower side wall. Edges of the pressure side upper wall fillet and the pressure side lower wall fillet have a combined dimension equal to or greater than 30 percent of a total dimension of the edge of the pressure side surface at an exit of the plurality of passages.

The method 200 may include operating a gas turbine engine that includes a turbine section having a turbine component formed in the steps 212-216. While operating the gas turbine engine, the method 200 may include directing cooling gas to the cooling system that includes the plurality of passages within the airfoil to flow a stream of the cooling fluid therethrough. The method 200 may include directing the cooling fluid from exits of the plurality of passages to the slots to discharge the cooling fluid therefrom. The method 200 may end at 218.

The systems and methods disclosed herein, including the gas turbine engine 100 of the aircraft 99, provide various benefits over certain existing systems and methods. For example, trailing edge cooling slots are potential weak points in the overall durability of airfoils, whether from high cycle fatigue (HCF) due to vibration, low cycle fatigue (LCF) due to high stresses, or thermo-mechanical fatigue due to a combination of high stress and high metal temperature. The systems and methods disclosed herein provide innovative, low-cost solutions that may reduce airfoil trailing edge metal temperatures, may reduce peak stresses, and may reduce aerodynamic losses for improved performance. For example, the upper and lower pressure side wall fillets extend the metering section aft. This structure may inhibit the flow path hot gas ingestion onto the slot surfaces thereby reducing trailing edge metal temperatures in the cooling slots, enhance lateral diffusion of the slot flow thereby providing cooler air to the land trailing edge and reducing the land trailing edge metal temperature, enhance lateral thermal conduction thereby reducing peak metal temperature at the high stress locations in the trailing edge cooling slot, and provide attenuation of stress concentrations thereby enhancing thermo-mechanical fatigue life.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A turbine component, comprising:
an airfoil having an upper end, a lower end, a leading edge, a trailing edge, a pressure side surface, and a suction side surface;
a cooling system that includes a plurality of passages within the airfoil that are configured to flow a cooling fluid therethrough; and
slots open to the pressure side surface of the airfoil adjacent the trailing edge thereof, the slots in fluidic communication with the plurality of passages and configured to discharge the cooling fluid therefrom,
wherein the slots are each defined by a slot upper side wall and an oppositely disposed slot lower side wall, the pressure side surface, and a slot bottom defined by the suction side surface, wherein the pressure side surface includes a pressure side upper wall fillet coupled to the slot upper side wall and a pressure side lower wall fillet coupled to the slot lower side wall, wherein a first portion of an edge of the pressure side surface at an exit of the plurality of passages is defined at a first intersection of the pressure side surface and the pressure side upper wall fillet and a second portion of the edge of the pressure side surface at the exit of the plurality of passages is defined at a second intersection of the pressure side surface and the pressure side lower wall fillet, wherein the first portion and the second portion of the edge have a combined dimension equal to or greater than 30 percent of a total dimension of the edge,
wherein the slots are separated by lands, wherein the slot upper side wall and the slot bottom are coupled with an upper slot side wall fillet and the slot lower side wall and the slot bottom are coupled with a lower slot side wall fillet, and both the upper slot side wall fillet and the lower slot side wall fillet have monotonically increasing radii of curvature from the exit of the plurality of passages to a trailing edge of the slot to promote a reduction in entrainment of vorticities rolling off the lands into the upper slot side wall fillet and the lower slot side wall fillet thus enhancing the cooling of the trailing edge of the airfoil.

2. The turbine component of claim 1, wherein the edges of the pressure side upper wall fillet and the pressure side lower wall fillet have a combined dimension equal to or greater than 70 percent of the total dimension of the edge of the pressure side surface at the exit of the plurality of passages.

3. The turbine component of claim 1, wherein the edges of the pressure side upper wall fillet and the pressure side lower wall fillet have a combined dimension equal to 100 percent of the total dimension of the edge of the pressure side surface at the exit of the plurality of passages, wherein the pressure side upper wall fillet and the pressure side lower wall fillet meet at a tangent point.

4. The turbine component of claim 1, wherein the pressure side upper wall fillet and the pressure side lower wall fillet have radii of curvature that vary.

5. The turbine component of claim 1, wherein the slots are coupled to the plurality of passages by metering sections, and the pressure side upper wall fillet and the pressure side lower wall fillet, in combination, extend the metering sections aft toward the trailing edge of the airfoil.

6. (canceled)

7. The turbine component of claim 1, wherein each of the slots has a central axis extending from the exit of the plurality of passages to a trailing edge of the slot, wherein edges of the slot upper side wall and the slot lower side wall flare outward from the central axis, and the slots are separated by tapering teardrop-shaped lands.

8. The turbine component of claim 1, wherein the turbine component is a turbine blade configured to be installed in a gas turbine engine.

9. The turbine component of claim 1, wherein the turbine component is a turbine vane configured to be installed in a gas turbine engine.

10. A method, comprising:
forming a turbine component that includes an airfoil having an upper end, a lower end, a leading edge, a trailing edge, a pressure side surface, and a suction side surface;
forming a cooling system that includes a plurality of passages within the airfoil that are configured to flow a cooling fluid therethrough; and
forming slots in the airfoil open to the pressure side surface of the airfoil adjacent the trailing edge thereof, the slots in fluidic communication with the plurality of passages and configured to discharge the cooling fluid therefrom, wherein the slots are each defined by a slot upper side wall and an oppositely disposed slot lower side wall, the pressure side surface, and a slot bottom defined by the suction side surface, wherein the pressure side surface includes a pressure side upper wall fillet coupled to the slot upper side wall and a pressure side lower wall fillet coupled to the slot lower side wall, wherein a first portion of an edge of the pressure side surface at an exit of the plurality of passages is defined at a first intersection of the pressure side surface and the pressure side upper wall fillet and a second portion of the edge of the pressure side surface at the exit of the plurality of passages is defined at a second intersection of the pressure side surface and the pressure side lower wall fillet, wherein the first portion and the second portion of the edge have a combined dimension equal to or greater than 30 percent of a total dimension of the edge, wherein the slots are formed to be separated by lands,
wherein the slot upper side wall and the slot bottom are formed to couple with an upper slot side wall fillet and the slot lower side wall and the slot bottom are coupled with a lower slot side wall fillet, and both the upper slot side wall fillet and the lower slot side wall fillet have monotonically increasing radii of curvature from the exit of the plurality of passages to a trailing edge of the slot to promote a reduction in entrainment of vorticities rolling off the lands into the upper slot side wall fillet and the lower slot side wall fillet thus enhancing the cooling of the trailing edge of the airfoil.

11. The method of claim 10, wherein the edges of the pressure side upper wall fillet and the pressure side lower wall fillet are formed to have a combined dimension equal to or greater than 70 percent of the total dimension of the edge of the pressure side surface at the exit of the plurality of passages.

12. The method of claim 10, wherein the edges of the pressure side upper wall fillet and the pressure side lower wall fillet are formed to have a combined dimension equal to 100 percent of the total dimension of the edge of the pressure side surface at the exit of the plurality of passages, wherein the pressure side upper wall fillet and the pressure side lower wall fillet meet at a pressure side wall fillet tangent point.

13. The method of claim 10, wherein the pressure side upper wall fillet and the pressure side lower wall fillet are formed to have radii of curvature that vary.

14. The method of claim 10, wherein the slots are formed to couple to the plurality of passages by metering sections, and the pressure side upper wall fillet and the pressure side lower wall fillet, in combination, extend the metering sections aft toward the trailing edge of the airfoil.

15. (canceled)

16. The method of claim 10, wherein each of the slots has a central axis extending from the exit of the plurality of passages to a trailing edge of the slot, wherein edges of the slot upper side wall and the slot lower side wall are formed to flare outward from the central axis, and the slots are formed to be separated by tapering teardrop-shaped lands.

17. The method of claim 10, wherein the turbine component is a turbine blade and the method includes installing the turbine blade in a gas turbine engine.

18. The method of claim 10, wherein the turbine component is a turbine vane and the method includes installing the turbine vane in a gas turbine engine.

19. The method of claim 10, further comprising:
operating a gas turbine engine that includes a turbine section having the turbine component therein;
directing the cooling fluid to the cooling system that includes the plurality of passages within the airfoil to flow the cooling fluid therethrough; and
directing the cooling fluid from exits of the plurality of passages to the slots to discharge the cooling fluid therefrom.

20. A gas turbine engine, comprising:
a compressor section;
a combustor section; and
a turbine section having a turbine component that includes:
an airfoil having an upper end, a lower end, a leading edge, a trailing edge, a pressure side surface, and a suction side surface;
a cooling system that includes a plurality of passages within the airfoil that are configured to flow a cooling fluid therethrough; and
slots open to the pressure side surface of the airfoil adjacent the trailing edge thereof, the slots in fluidic communication with the plurality of passages and configured to discharge the cooling fluid therefrom,
wherein the slots are each defined by a slot upper side wall and an oppositely disposed slot lower side wall, the pressure side surface, and a slot bottom defined by the suction side surface, wherein the pressure side surface includes a pressure side upper wall fillet coupled to the slot upper side wall and a pressure side lower wall fillet coupled to the slot lower side wall, wherein a first portion of an edge of the pressure side surface at an exit of the plurality of passages is defined at a first intersection of the pressure side surface and the pressure side upper wall fillet and a second portion of the edge of the pressure side surface at the exit of the plurality of passages is defined at a second intersection of the pressure side surface and the pressure side lower wall fillet, wherein the first portion and the second portion of the edge have a combined dimension equal to or greater than 30 percent of a total dimension of the edge,
wherein the slots are coupled to the plurality of passages by metering sections, and the pressure side upper wall fillet and the pressure side lower wall fillet, in combination, extend the metering sections aft toward the trailing edge of the airfoil,
wherein each of the slots has a central axis extending from the exit of the plurality of passages to a trailing edge of the slot, wherein edges of the slot upper side wall and the slot lower side wall flare outward from the central axis, and the slots are separated by tapering teardrop-shaped lands, wherein the slot upper side wall and the slot bottom are coupled with an upper slot side wall fillet and the slot lower side wall and the slot bottom are coupled with a lower slot side wall fillet, and both the upper slot side wall fillet and the lower slot side wall fillet have monotonically increasing radii of curvature from the exit of the plurality of passages to a trailing edge of the slot to promote a reduction in entrainment of vorticities rolling off the lands into the upper slot side wall fillet and the lower slot side wall fillet thus enhancing the cooling of the trailing edge of the airfoil.

21. The gas turbine engine of claim 20, wherein the edges of the pressure side upper wall fillet and the pressure side lower wall fillet have a combined dimension equal to 100 percent of the total dimension of the edge of the pressure side surface at the exit of the plurality of passages, wherein the pressure side upper wall fillet and the pressure side lower wall fillet meet at a tangent point.

22. The gas turbine engine of claim 20, wherein the pressure side upper wall fillet and the pressure side lower wall fillet have radii of curvature that vary.
